(19) United States
(12) Patent Application Publication
(10) Pub. No.: US 2013/0308216 A1
(43) Pub. Date: Nov. 21, 2013

(54) LENS WITH LENS TUBE AND METHOD FOR MANUFACTURING THE SAME

(71) Applicant: ALPS ELECTRIC CO., LTD., Tokyo (JP)

(72) Inventors: Tsuyoshi MATSUMOTO, Miyagi-ken (JP); Hideyuki IMAI, Miyagi-ken (JP)

(73) Assignee: ALPS ELECTRIC CO., LTD., Tokyo (JP)

(21) Appl. No.: 13/947,950

(22) Filed: Jul. 22, 2013

Related U.S. Application Data
(63) Continuation of application No. PCT/JP2012/050671, filed on Jan. 16, 2012.

(30) Foreign Application Priority Data
Mar. 3, 2011 (JP) 2011-045880

(51) Int. Cl. G02B 7/02; B26D 3/06

(52) U.S. Cl. CPC G02B 7/022; B26D 3/06
USPC 359/829; 83/875

(57) ABSTRACT

Provided is a lens with a lens tube in which, in the lens with a lens tube which is constituted by a cylindrical lens tube and a lens that is held by the lens tube, the lens tube provides a lens holding portion which comes into contact with an outer circumference surface of the lens, the lens holding portion includes a first groove portion which is consecutively formed in a spiral, a second groove portion which is consecutively formed in a spiral, and an intermediate region which divides the first groove portion and the second groove portion, and the intermediate region is constituted by a protruding portion and a third groove portion.

### CLAIM OF PRIORITY

This application is a Continuation of International Application No. PCT/JP2012/050671 filed on Jan. 16, 2012, which claims benefit of Japanese Patent Application No. 2011-045880 filed on Mar. 3, 2011. The entire contents of each application noted above are hereby incorporated by reference.

### BACKGROUND OF THE INVENTION

1. Field of the Invention

The present invention relates to a lens with a lens tube that stores a lens in a lens tube and a method for manufacturing the same, and particularly, to a lens with a lens tube that obtains airtightness stably and a method for manufacturing the same.

2. Description of the Related Art

In the related art of a field such as an optical communication, a lens with a lens tube in which a lens is held in a cylindrical lens tube has been known. The lens with a lens tube is used, including a function to send collimator light to an isolator in an optical communication device or to collect a laser beam in an end surface of an optical fiber or the like. In addition, an airtight structure, which prevents a semiconductor laser or the like from deteriorating due to an oxidation, by covering an electrical component such as a semiconductor laser installed on a substrate with the lens tube and attaching the electrical component in an airtightly sealed state, has been known.

In the airtight structure described above, the lens with a lens tube is installed so as to fix the semiconductor laser to a metal substrate and cover the substrate, and the substrate and a lower surface of the lens tube are joined by welding. The lens with a lens tube used as described above is disclosed, for example, in Japanese Unexamined Patent Application Publication No. 2005-208330.

In Japanese Unexamined Patent Application Publication No. 2005-208330, after installing a cylindrical part in a lens holder (lens tube) which is manufactured with stainless steel-based ferrite steel and fixing the lens in the lens holder, the cylindrical part is covered with a base (substrate) loaded with the semiconductor laser, filled with an inert gas, and sealed airtightly by welding or the like.

### SUMMARY OF THE INVENTION

However, the lens tube of the stainless steel-based ferrite steel is manufactured by a cutting process, and thus, a spiral-shaped cutting trace is formed in an inner circumference surface thereof. The cutting trace is such a shape that a minute groove portion is installed, and therefore, groove portions which are connected in a spiral are formed in a rotary cutting of the inner circumference surface of the lens tube. Accordingly, in the lens tube for an airtight sealing, when it is not possible to sufficiently fill consecutive groove portions of the cutting trace in the inner circumference surface of the lens tube formed in the lens with a glass material, it is found that a minute leak path is formed through the groove portions.

When the minute leak path remains in an optical communication device which joins the lower surface of the lens tube and the substrate by welding, the semiconductor laser or the like is apt to deteriorate, by flowing out the inert gas with which is filled and flowing in an oxidizing gas. Consequently, when a leak test is performed in the lens with a lens tube for joining by welding, it is necessary to assure securement of airtightness. Therefore, it is preferable that the lens with a lens tube in which the minute leak path does not remain, but it is difficult to obtain airtightness stably by a practical manufacturing method.

An object of the present invention is to provide a lens with a lens tube that obtains airtightness stably in consideration of the above problems.

### Means for Solving the Problems

The present invention provides lens with a lens tube, including: a cylindrical lens tube; and a lens that is held by the lens tube, in which the lens tube provides a lens holding portion which comes into contact with an outer circumference surface of the lens, in which the lens holding portion includes a first groove portion which is consecutively formed in a spiral, a second groove portion which is consecutively formed in a spiral, and an intermediate region which divides the first groove portion and the second groove portion from each other, and in which the intermediate region is constituted by a protruding portion and a third groove portion.

For this reason, when the first groove portion and the second groove portion are divided by the intermediate region into consecutive spiral grooves which become a leak path, and the lens is integrally formed by a press inside of the lens tube, a glass material comes into contact with the protruding portion of the intermediate region, and the third groove portion of the intermediate region is sufficiently filled with the glass material.

Accordingly, the lens with a lens tube of the present invention obtains airtightness stably.

Furthermore, it is suitable that the protruding portion and the third groove portion are installed consecutively in an approximately circumferential direction of the lens holding portion and the intermediate region which is constituted by the protruding portion, and the third groove portion rounds an inner circumference surface of the lens holding portion at least once. Therefore, the first groove portion and the second groove portion are fully divided by the intermediate region which rounds once, and thus, airtightness is obtained stably even when the first groove portion and the second groove portion include a non-consecutive leak path.

It is preferable that the third groove portion is formed in a deep groove in comparison with the first groove portion and the second groove portion. Therefore, the glass material is easily buried in the third groove portion and filled the third groove portion in comparison with the first groove portion and the second groove portion.

It is practical that the protruding portion includes at least a first protruding region and a second protruding region, and the third groove portion includes an one end portion and the other end portion in approximately the circumferential direction, and the one end portion and the first groove portion are installed consecutively in approximately the circumferential direction through the first protruding region, the other end portion and the second groove portion are installed consecutively in the approximately circumferential direction through the second protruding region, and the intermediate region rounds the inner circumference surface of the lens holing portion at least once, in a spiral. In this case, consecutive spiral grooves are divided in each of protruding regions, and the first groove portion and the second groove portion are divided by the intermediate region which rounds once, and thus, airtightness is obtained more stably.

Moreover, the present invention provides a method for manufacturing a lens with a lens tube which includes a cylindrical lens tube and a lens that is held by the lens tube, in which the lens tube provides a lens holding portion which comes into contact with an outer circumference surface of the lens, in which the lens holding portion is formed by a cutting process, in which the cutting process includes a process of installing a first groove portion which is formed consecutively in a spiral, a second groove portion which is formed consecutively in a spiral, and an intermediate region which divides the first groove portion and the second groove portion, and in which the process of installing the intermediate region is a process of forming a protruding portion and a process of forming a third groove portion.

From this reason, the lens tube that divides consecutive grooves which become a leak path, is obtained, only by adding a process of installing the intermediate region to a normal process of cutting in a spiral in the state to be held by a processing device which cuts a lens tube. Therefore, it is possible to manufacture the lens with a lens tube that obtains airtightness stably.

It is practical that the process of installing the first groove portion is a first cutting process, and the process of forming the protruding portion is a non-cutting process which follows the first cutting process, and the process of installing the second groove portion is a second cutting process which is performed after the non-cutting process. Therefore, it is possible to perform each of the processes consecutively by the processing device, and manufacture the lens with a lens tube easily.

It is suitable that the process of forming the third groove portion is a third cutting process of forming a deep groove in comparison with the first groove portion and the second groove portion. Accordingly, the lens tube becomes a lens tube in which the glass material easily adheres to the intermediate region, and airtightness is obtained stably.

According to the present invention as described above, it is possible to provide a lens with a lens tube that obtains airtightness stably.

### BRIEF DESCRIPTION OF THE DRAWINGS

FIG. 1 is a cross-sectional view illustrating a lens with a lens tube according to a first embodiment.

FIG. 2 is an enlarged cross-sectional view illustrating a part of the lens with a lens tube according to the first embodiment.

FIG. 3 is an enlarged cross-sectional view illustrating a part of the lens with a lens tube according to the first embodiment.

FIG. 4 is an explanatory diagram of the state in which a non-consecutive leak path remains.

FIG. 5 is a cross-sectional view illustrating a lens tube which is applied to the lens with a lens tube according to the first embodiment.

FIG. 6 is an explanatory diagram of a process of manufacturing the lens tube of FIG. 5.

FIG. 7 is an explanatory diagram of a process of forming a lens of the lens with a lens tube.

FIG. 8 is a cross-sectional view illustrating a lens with a lens tube according to a second embodiment.

FIG. 9 is a cross-sectional view illustrating a lens tube which is applied to the lens with a lens tube according to the second embodiment.

FIG. 10 is a cross-sectional view illustrating a lens tube which is applied to a lens with a lens tube according to a third embodiment.

FIG. 11 is a graph illustrating a test result of a leak test.

FIG. 12 is a schematic cross-sectional view illustrating a structure of a CAN package which is airtightly sealed using a lens with a lens tube.

### DESCRIPTION OF THE PREFERRED EMBODIMENTS

### First Embodiment

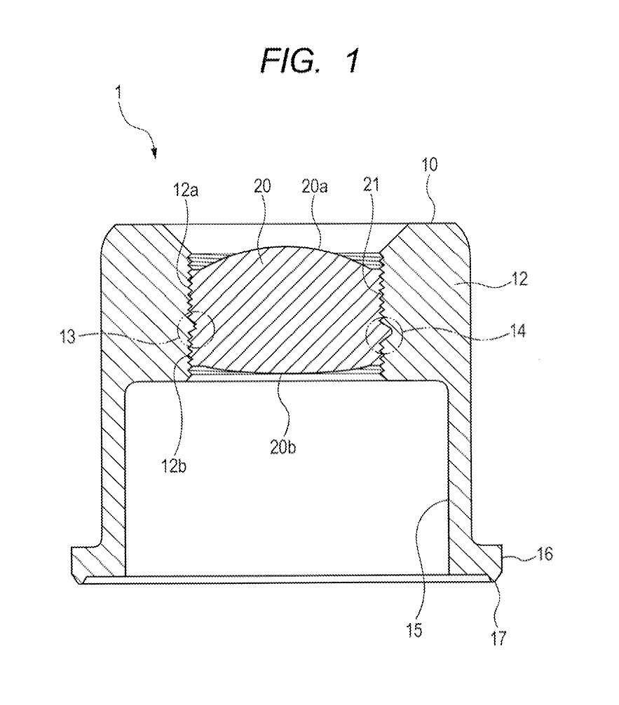

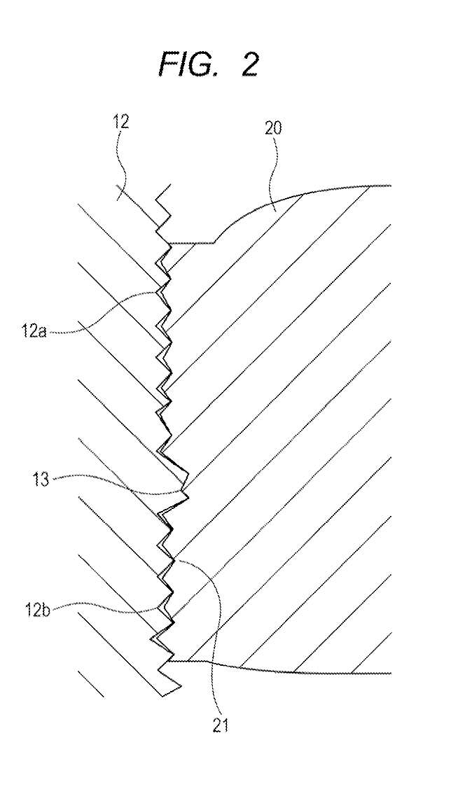

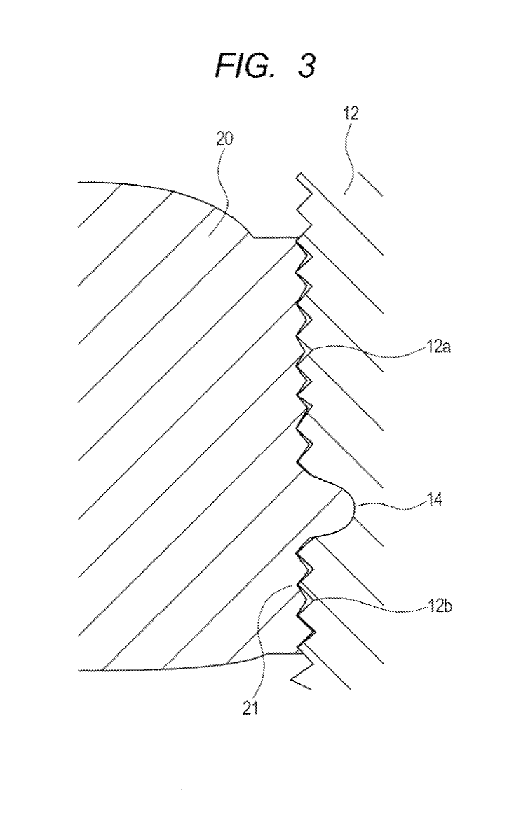

A first embodiment of the present invention will be explained in detail with reference to the drawings. Furthermore, the drawings change the dimensions appropriately and emphasize a characteristic part in order to understand the explanation easily. FIG. 1 is a cross-sectional view illustrating a lens with a lens tube 1 according to the first embodiment, and FIG. 2 and FIG. 3 are enlarged cross-sectional views illustrating parts thereof. As shown in these drawings, in the embodiment, the lens with a lens tube 1 is constituted by a lens tube 10, which is formed in a cylindrical shape, and a lens 20. The lens 20 is a glass lens including a first optical surface 20a and a second optical surface 20b.

The lens tube 10 is formed by cutting ferrite-based stainless steel. In addition, the lens 20 is formed by a glass material is pressed in the lens tube 10. The material that has a linear expansion coefficient slightly larger than the glass material is used as the stainless steel which forms the lens tube 10. As a result, when a high temperature state at the time of pressing the lens 20 returns to room temperature, a force is applied to a direction to tighten an outer circumference surface 21 of the lens 20 in the lens tube 10, and thus, it is possible to hold the lens 20 reliably.

FIG. 12 is a schematic cross-sectional view illustrating a structure of a CAN package 2 which is airtightly sealed using the lens with a lens tube 1. Here, as shown in FIG. 1, the lens tube 10 is integrally formed by a lens holding portion 12 which is located in one opening side and holds the lens 20, a component storing portion 15 which is located in the other opening side and stores an electrical component 40 inside thereof, and a flange portion 16 which is formed so as to extend to an outer circumference side from an opening end of the component storing portion 15. A welding joint portion 17 is formed in a lower surface of the flange portion 16 of the lens tube 10 in order to join the lens tube 10 and a substrate 50 by welding. In the case of the welding, a top surface of the flange portion 16 is pressed by an electrode in an inert gas, and the welding joint portion 17 is pressurized with respect to the substrate 50. In this state, an electric current flows from the electrode to the substrate 50, and thus, a tip portion of the welding joint portion 17 is welded and joined with the substrate 50. In this way, the CAN package 2 is manufactured as shown in FIG. 12, and therefore it is possible to seal the electrical component 40 in an airtight state.

Both the lens holding portion 12 and the component storing portion 15 as shown in FIG. 1 are formed so as to have a cylindrical shape, and the outer circumference surface 21 of the lens 20 comes into contact with an inner circumference surface of the lens holding portion 12. As shown in FIG. 1, FIG. 2 and FIG. 3, a protruding portion 13 and a third groove portion 14 are formed in an intermediate region of the inner circumference surface of the lens holding portion 12 that comes into contact with the outer circumference surface 21. In the embodiment, it is possible to provide the lens with a lens tube 1 that obtains airtightness stably, since the protruding portion 13 and the third groove portion 14 are formed in the inner circumference surface of the lens holding portion 12 as described above.

The effects will be explained in detail in comparison with a configuration of the related art.

The lens tube 10 is formed by the ferrite-based stainless steel which is cut by a processing device such as a lathe, and thus, a spiral-shaped cutting trace remains by a rotation and feeding in the processing device. Generally, a special processing such as a polishing is high in cost, and consequently it is hard to adopt it. In most cases, a cutting finishing of the lens tube 10 is a cutting finishing of processing accuracy which matches with design specifications of the lens with a lens tube 1. Therefore, a cutting trace of the cutting finishing exists over the entire surface of the lens tube 10. This cutting trace is measured by a surface roughness measuring instrument as surface roughness of a processing side.

In the related art, even in the state of considering the spiral-shaped cutting trace to be one consecutive groove, it is considered that a glass material is buried so as to push an air of the groove and the glass material is filled the cutting trace without a gap. However, it is found that the cutting trace is relatively a minute groove shape, and thus, the air remains in a bottom portion of the groove and a gap which is not filled with the glass is easily generated. By this gap, a minute leak path is formed over both sides of the lens 20 after the forming.

Regardless of joining the lens tube 10 and the substrate 50 by welding as the CAN package 2 and filling with an inert gas when the leak path remains in this way, the deterioration of a semiconductor laser or the like occurs by flowing out the inert gas and flowing in an oxidizing gas.

The consecutive spiral groove basically has an unavoidable problem even if a depth of the groove includes the difference depending on a processing condition, as long as the cutting processing is used. Furthermore, FIG. 1 or the like is a cross-sectional view in which the groove of the cutting trace in only the lens holding portion 12 is emphasized, but the similar cutting trace also exists in the other cutting side as a consecutive groove.

In this embodiment, the intermediate region which is constituted by the protruding portion 13 and the third groove portion 14 is installed in a part of the lens holding portion 12 which comes into contact with the outer circumference surface 21 of the lens 20 in order to divide the consecutive groove. It is preferable that the intermediate region which is constituted by the protruding portion 13 and the third groove portion 14 rounds the inner circumference surface of the lens holding portion 12 at least once.

If the lens tube 10 is processed so as to install the intermediate region which is constituted by the protruding portion 13 and the third groove portion 14 in the part of the lens holding portion 12 in this way, a first groove portion 12a and a second groove portion 12b are divided by the intermediate region as consecutive spiral grooves, and the glass material of the lens 20 comes into contact with the protruding portion 13 of the intermediate region and the third groove portion 14 of the intermediate region is filled sufficiently with the glass material, when the lens 20 is integrally formed in the lens tube 10 by press.

Moreover, a cutting trace remains in a surface of the protruding portion 13 in the same manner of the first groove portion 12a and the second groove portion 12b, but it is possible to reduce such a possibility that the cutting trace in the surface of the protruding portion 13 becomes a leak path because it is divided as a consecutive groove by installing the third groove portion 14. When the third groove portion 14 is not installed in the intermediate region, there is the possibility of connecting the leak path by the cutting trace in the surface of the protruding portion 13 or a wound defect, and thus it is necessary for installing the third groove portion 14.

On the other hand, when only the third groove portion 14 as an intermediate region is installed and the protruding portion 13 is not installed, there is a possibility that the leak path which is connected from the first groove portion 12a to the second groove portion 12b cannot be cut off. A non-consecutive surface is formed by installing the protruding portion 13 at the same time, and at first, the glass material easily comes into contact with the protruding portion 13 at the time of forming of the lens 20, and thus, it is possible to reduce the possibility that the leak path cannot be cut off as described above.

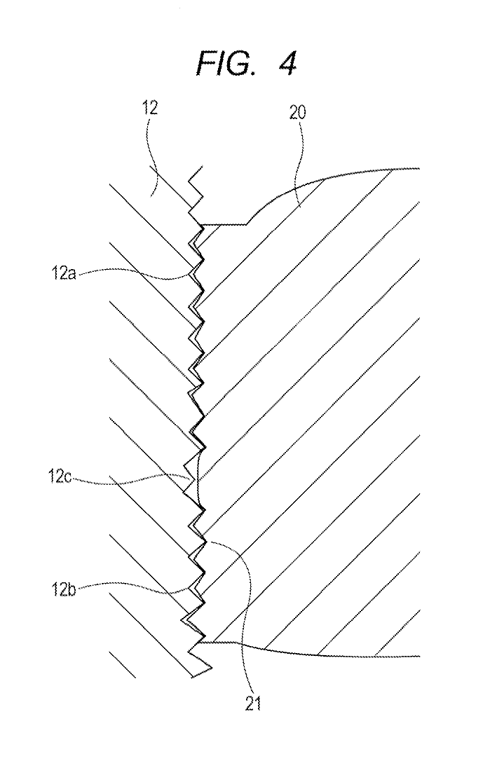

Furthermore, the first groove portion 12a and the second groove portion 12b have an undulation in the accuracy of the cutting process, as a result, a non-consecutive portion 12c may be formed. FIG. 4 is an explanatory diagram of the state in which a non-consecutive leak path is remained. When the intermediate region which is constituted by the protruding portion 13 and the third groove portion 14 does not round the inner circumference surface of the lens holding portion 12 once, there is a possibility in which the non-consecutive portion 12c cannot be divided depending on a position of a circumferential direction, and in this case, since the air easily remains, the non-consecutive leak path is apt to remain. As a result, the non-consecutive leak path is connected to the consecutive grooves, and thus, there is a possibility that a minute leak path is formed over both sides of the lens 20 after the formation. Therefore, it is suitable that the intermediate region which is constituted by the protruding portion 13 and the third groove portion 14 rounds the inner circumference surface of the lens holding portion 12 at least once. In this way, the first groove portion 12a and the second groove portion 12c are fully divided over the entire circumference by the intermediate region rounds, and airtightness is obtained even when the first groove portion 12a and the second groove portion 12b have a non-consecutive leak path.

It is preferable that the third groove portion 14 is formed in a deep groove in comparison with the first groove portion 12a and the second groove portion 12b. In this way, the third groove portion 14 is widely formed in comparison with the first groove portion 12a and the second groove portion 12b, and thus, the glass material is easily buried in and is filled the third groove portion 14 more sufficiently.

As described above, the lens tube 10 of the embodiment obtains airtightness stably, and since the glass material easily adheres to the intermediate region of the lens holding portion 12.

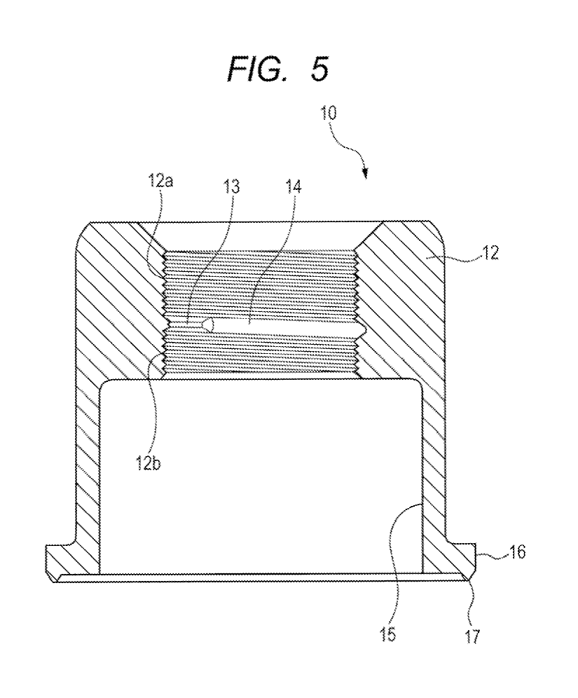

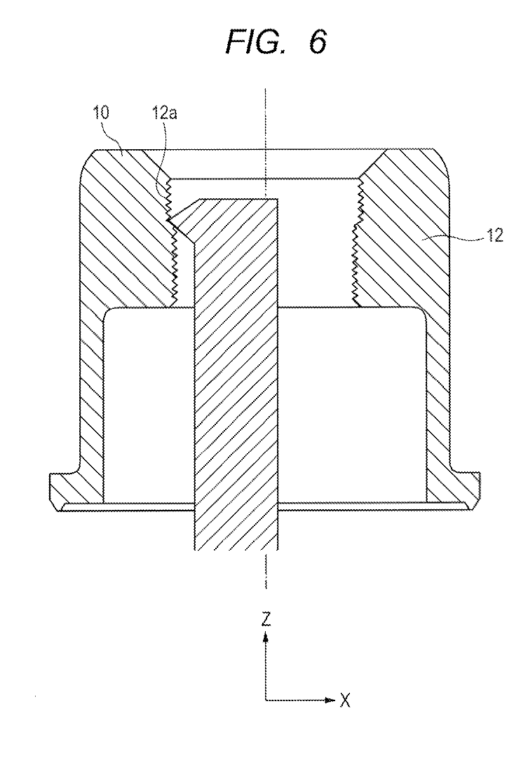

Next, a method for manufacturing the lens with a lens tube 1 according to an embodiment will be explained. FIG. 5 is a cross-sectional view illustrating the lens tube 10 which is applied to the lens with a lens tube 1 according to the first embodiment, and FIG. 6 is an explanatory diagram of a process of manufacturing the lens tube 10 of FIG. 5.

The material for a lens tube is added to a processing machine such as an automatic lathe which can perform a cutting process with stainless steel. As shown in FIG. 6, the processing machine may be used as a main axis is rotated, the depth of the cutting is set to be appropriate in the X direction, the amount of sending is set in the Z direction, and the number of the control axes which perform an end face processing, an external form processing, or an inner surface processing are two or more. In addition, a chuck size is selected depending on the size of the material for a lens tube. If an external form is approximately 4 mm of the maximum diameter, the chuck may be 3 inches generally.

A cutting process condition and a cutting supplement (cutting oil or the like) are appropriately selected so as to obtain necessary dimensions and the finishing state. As shown in FIG. 6, in the final cutting of the inner circumference surface of the lens holding portion 12, the non-cutting process, in which the depth of the cutting is set to 0 if the point of a blade of the processing byte arrives at the intermediate region through a cutting process of the first groove portion 12a, is installed. An inner circumference surface of the non-cutting protrudes more than the first groove portion 12a, as the protruding portion 13 of the height corresponding to the depth of the cutting in the first groove portion 12a. Consequently, the cutting process of the third groove portion 14 is installed so as to set the depth of the cutting to approximately 10 μm. A groove of a predetermined length (a rotation of the material which is an object to be processed) is formed, and then, the process which is an object to be cutting-processed is installed again and a second protruding portion (not shown) is installed. After that, the cutting process is performed with the second groove portion 12b to the component storing portion 15 under a processing condition in the same manner of the first groove portion 12a.

According to the method for manufacturing described above, it is possible to perform each process consecutively with the processing device and to manufacture easily.

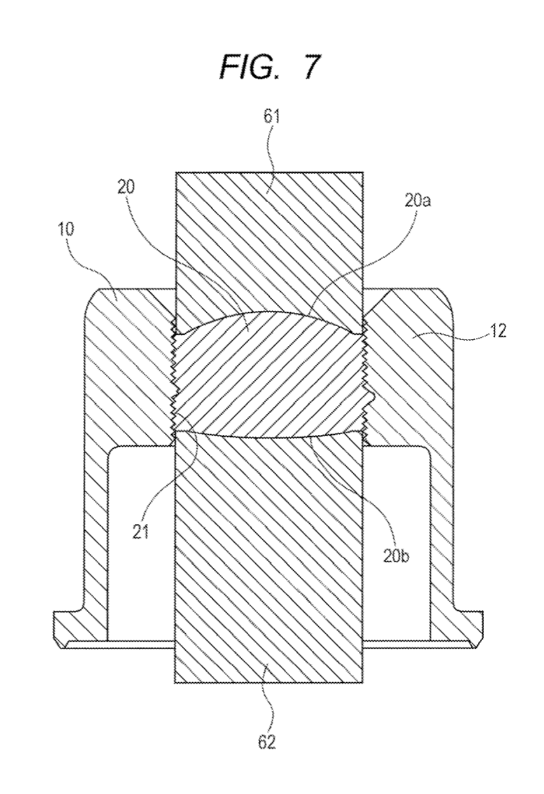

Using the cutting processed lens tube 10 in a predetermined shape as described above, the lens 20 is integrally formed by a forming device. FIG. 7 is an explanatory diagram of a process of forming the lens 20 of the lens with a lens tube 1. As shown in FIG. 7, by a mold including an upper die which prepares a core 61 including a transfer surface of the first optical surface 20a and a lower die which prepares a core 62 including a transfer surface of the second optical surface 20b, spherical or cylindrical glass material is pressed in a heating state and the lens 20 is formed into a predetermined surface shape. At this time, the glass material compressed in the top and bottom direction of FIG. 7 is pushed out so as to come into contact with the lens holding portion 12 and the outer circumference surface 21 is compressed to the lens holding portion 12.

In a combination case such that a linear expansion coefficient of the lens tube 10 is slightly larger than a linear expansion coefficient of the lens 20, the lens with a lens tube 1 which protrudes from the forming device holds the lens 20 very closely with the moderate tightening force.

After that, an antireflection film is formed (AR coat) by vapor deposition or the like in the first optical surface 20a and the second optical surface 20b of the lens 20, as necessary. In the lens with a lens tube 1 in order to seal the electrical component 40 in an airtight state, when an examination including a leak test is performed, the discovered leak that is more than a predetermined leak amount is discarded as a defective product.

It is possible to use SUS430 as stainless steel of the lens tube 10. In addition, as the lens 20 which is combined with the lens tube 10, it is possible to select from the glass material of which the linear expansion coefficient is approximately from 70×10⁻⁷/K to 90×10⁻⁷/K. The glass material described above is, for example, L-BA35, L-LAH84, and L-LAH53 manufactured by Ohara Inc., or P-SK57 and P-LASF47 manufactured by Schott AG. Moreover, in a combination case such that the linear expansion coefficient of the lens tube 10 is slightly larger than the linear expansion coefficient of the lens 20, it is possible to apply the present invention without limiting to the material described above.

In the manufacturing process described above, the plural protruding portion 13 is formed so as to install consecutively in the both ends of the third groove portion 14, without limiting to this, one end of the third groove portion 14 may be consecutively installed in the protruding portion 13, or the other end may be consecutively installed in the first groove portion 12a or the second groove portion 12b.

In addition, other than the procedure described above, the cutting process of the inner circumference surface of the lens holding portion 12 may be a process in an order in which the third groove portion 14 is cut in the intermediate region in advance and the first groove portion 12a and the second groove portion 12b except the intermediate region are cut. Otherwise, it may be a process in an order in which a protruding region of the intermediate region is installed between the first groove portion 12a and the second groove portion 12b by a non-cutting process, and then, and the third groove portion 14 is formed by adding a cutting process to a part of the protruding region. In this case, in the protruding region described above, the region which remains without forming the third groove portion 14 becomes the protruding portion 13.

As described above, in the state of holding by the processing device which cuts the lens tube 10, by adding a process of installing the intermediate region to a general process of cutting in a spiral, the lens tube 10 that divides the consecutive grooves which becomes the leak path is obtained. Therefore, airtightness is obtained stably.

### Second Embodiment

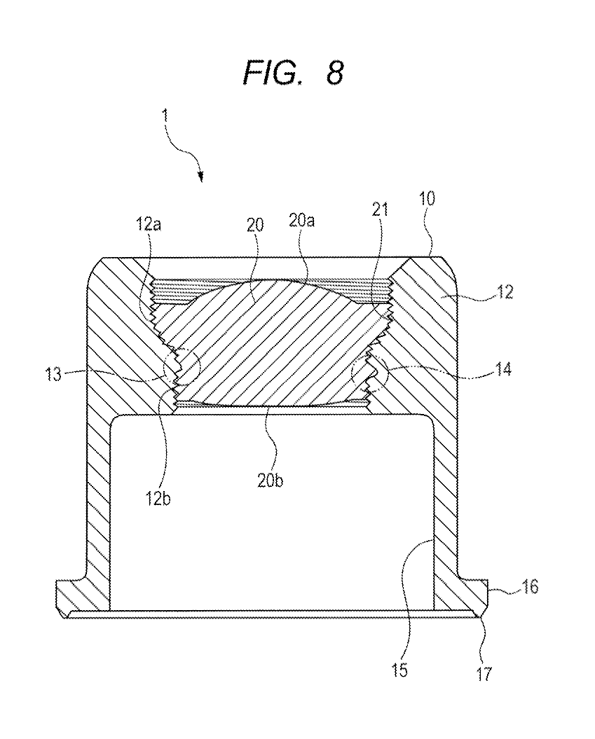

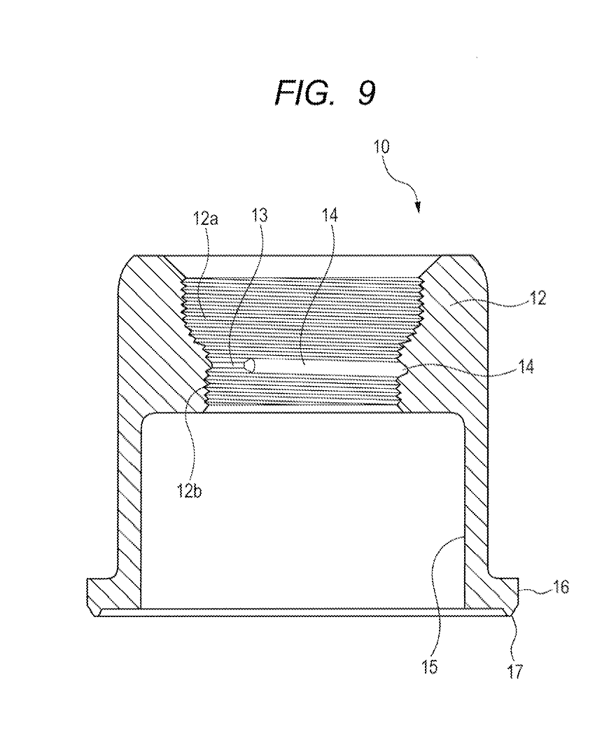

FIG. 8 is a cross-sectional view illustrating the lens with a lens tube 1 according to a second embodiment, and FIG. 9 is a cross-sectional view illustrating the lens tube 10 which is applied to the lens with a lens tube 1. A point which is different from the first embodiment is a shape of the inner circumference surface of the lens holding portion 12 and a shape of the outer circumference surface 21 of the formed lens 20 which come into contact with the shape. Other main configurations and the materials are similar to the first embodiment.

In the embodiment, the first groove portion 12a is formed in two cylindrical inner circumference surfaces which vary an inner diameter, and an inclined surface (a part of a conical surface) which consecutively binds the inner circumference surfaces thereof. However, it is set to form consecutive grooves in a turning process of cutting these, and a cutting process is consecutively performed to not deteriorate the surface roughness of a finishing surface.

As described above, even if the first groove portion 12a is formed in the lens holding portion 12 including the inclined surface, there is a possibility that consecutive grooves become the leak path at the time of formation in a cutting process of the related art, and thus, it is effective to install the protruding portion 13 and the third groove portion 14. The formation of the intermediate region including the protruding portion 13 and the third groove portion 14 is similar to the first embodiment.

Therefore, the lens with a lens tube 1 of the second embodiment obtains airtightness stably.

### Third Embodiment

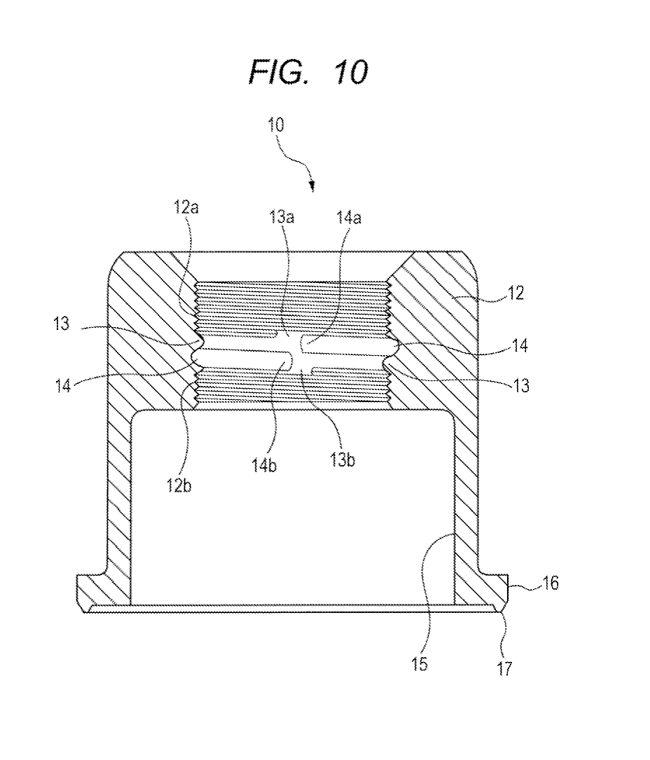

FIG. 10 is a cross-sectional view illustrating the lens tube 10 which is applied to the lens with a lens tube 1 according to a third embodiment. A point which is different from the first embodiment is a shape of the inner circumference surface of the lens holding portion 12, and in more detail, a shape of the protruding portion 13 and the third groove portion 14. Other main configurations and the material are similar to the first embodiment.

In the embodiment, the third groove portion 14 is widely formed in comparison with the first groove portion 12a and the second groove portion 12b, the third groove portion 14 rounds the inner circumference surface of the lens holding portion 12 approximately once, a first end portion 14a is consecutively installed in the first protruding region 13a, and a second end portion 14b is consecutively installed in the second protruding region 13b. In addition, the cutting trace also remains in the protruding portion 13 including the first protruding region 13a and the second protruding region 13b, but is not shown in FIG. 10.

In the forming of the intermediate region which is constituted by the protruding portion 13 and the third groove portion 14 to be wide, for example, after a non-cutting process of 10 rotations is installed with respect to the sending amount in the cutting condition of the first groove portion 12a in the finish cutting, a cutting of the third groove potion 14 is performed in approximately one rotation, the non-cutting process of 10 rotations is installed again, and thus, a cutting process of the second groove portion 12b is performed.

In addition, it is preferable that the third groove portion 14 is wide and is formed in a deep groove in comparison with the first groove portion 12a and the second groove portion 12b. In this way, in comparison with the first groove portion 12a and the second groove portion 12b, the glass material is easily buried and is filled more sufficiently in the third groove portion 14.

In the embodiment, the intermediate region which rounds once divides the first groove portion 12a and the second groove portion 12b fully, and thus, airtightness is obtained stably.

As described above, the lens tube 10 of the embodiment obtains airtightness stably by adhering the glass material easily to the intermediate region of the lens holding portion 12.

### Example

Airtightness of the manufactured lens with a lens tube 1 is measured by a leak test.

An amount of He leak is measured by attaching 28 pieces of test sample as an example of the related art and 100 pieces of test sample as an example to an airtight test device.

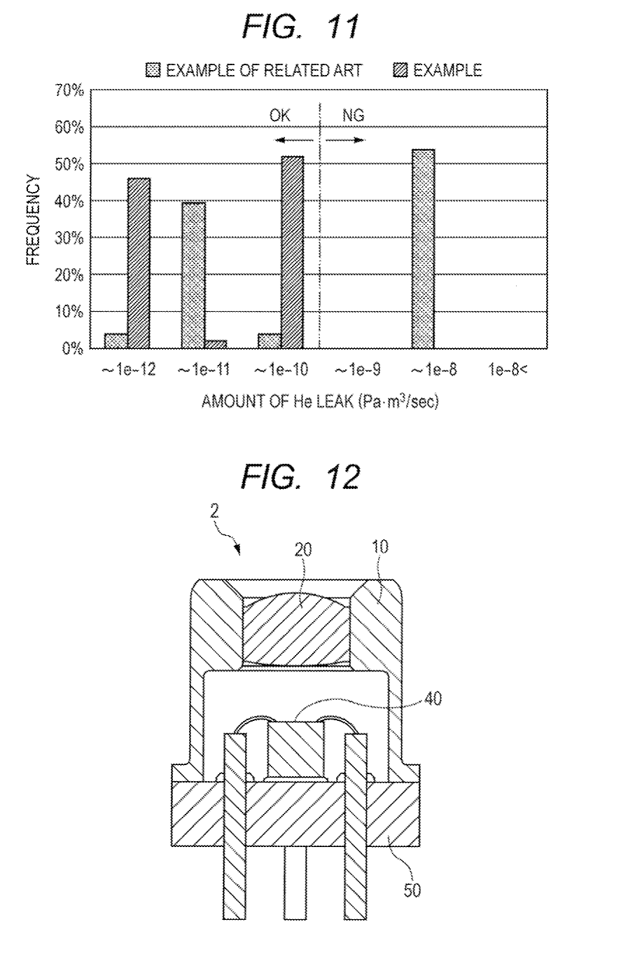

FIG. 11 is a graph illustrating a test result of the leak test. FIG. 11 is a frequency graph in which a horizontal axis is to divide the measured amount of He leaks in every range and a vertical axis is to plot a ratio of a number of a target samples with respect to a test sample parameter. When a specification of the leak test is lower than or equal to 1.01×10⁻¹⁰ Pa·m³/sec, 15 of NG products are confirmed in the example of the related art, and thus, more than half of the test samples are defective products. On the other hand, the specification is stably satisfied in the example, and the NG product is not confirmed. From this, the spiral-shaped cutting trace is divided in the test sample of the example, and it is considered that the glass material adheres to the intermediate region.

Therefore, the lens with a lens tube 1 of the present invention can secure airtightness stably and is suitable for the CAN package 2 which prevents the deterioration of semiconductor laser or the like by the oxidation.

According to the present invention as described above, it is possible to provide the lens with a lens tube 1 that obtains airtightness stably.

It should be understood by those skilled in the art that various modifications, combinations, sub-combinations and alterations may occur depending on design requirements and other factors insofar as they are within the scope of the appended claims of the equivalents thereof.

What is claimed is:

1. A lens with a lens tube, comprising:
a cylindrical lens tube; and
a lens that is held by the lens tube,
wherein the lens tube provides a lens holding portion which comes into contact with an outer circumference surface of the lens,
wherein the lens holding portion includes a first groove portion which is consecutively formed in a spiral, a second groove portion which is consecutively formed in a spiral, and an intermediate region which divides the first groove portion and the second groove portion from each other, and
wherein the intermediate region is constituted by a protruding portion and a third groove portion.

2. The lens with a lens tube according to claim 1,
wherein, in a cross section including a central axis of an outer diameter of the lens tube, the first groove portion and the second portion include a plurality of concave portions in a toothing shape which is constituted by a plurality of convex portions and the plurality of concave portions, and the protruding portion protrudes to a central axis direction more than the convex portions.

3. The lens with a lens tube according to claim 1,
wherein the protruding portion and the third groove portion are installed consecutively in an approximately circumferential direction of the lens holding portion, and the intermediate region which is constituted by the protruding portion and the third groove portion rounds an inner circumference surface of the lens holding portion at least once.

4. The lens with a lens tube according to claim 1,
wherein the third groove portion is formed in a deep groove in comparison with the first groove portion and the second groove portion.

5. The lens with a lens tube according to claim 3,
wherein the protruding portion includes at least a first protruding region and a second protruding region, and the third groove portion includes an one end portion and the other end portion in an approximately circumferential direction, and
wherein the one end portion and the first groove portion are installed consecutively in approximately the circumferential direction through the first protruding region, the other end portion and the second groove portion are installed consecutively in the approximately circumferential direction through the second protruding region, and the intermediate region rounds the inner circumference surface of the lens holing portion at least once, in a spiral.

6. A method for manufacturing a lens with a lens tube,
which includes a cylindrical lens tube and a lens that is held by the lens tube,
wherein the lens tube provides a lens holding portion which comes into contact with an outer circumference surface of the lens,
wherein the lens holding portion is formed by a cutting process,
wherein the cutting process includes a process of installing a first groove portion which is formed consecutively in a spiral, a second groove portion which is formed consecutively in a spiral, and an intermediate region which divides the first groove portion and the second groove portion, and
wherein the process of installing the intermediate region is a process of forming a protruding portion and a process of forming a third groove portion.

7. The method for manufacturing a lens with a lens tube according to claim 6,
wherein the process of installing the first groove portion is a first cutting process, and the process of forming the protruding portion is a non-cutting process which follows the first cutting process, and
wherein the process of installing the second groove portion is a second cutting process which is performed after the non-cutting process.

8. The method for manufacturing a lens with a lens tube according to claim 6,
wherein the process of forming the third groove portion is a third cutting process of forming a deep groove in comparison with the first groove portion and the second groove portion.
